(19) United States
(12) Patent Application Publication
(10) Pub. No.: US 2007/0157455 A1
(43) Pub. Date: Jul. 12, 2007

(54) Fenestration product and method and apparatus for manufacture

(76) Inventor: Charles D. Kownacki, Erie, PA (US)

Correspondence Address: MICHAEL BEST & FRIEDRICH, LLP, 100 E WISCONSIN AVENUE, Suite 3300, MILWAUKEE, WI, 53202, US

(21) Appl. No.: 11/640,456

(22) Filed: Dec. 15, 2006

Related U.S. Application Data
(63) Continuation-in-part of application No. 11/323,563, filed on Dec. 30, 2005.

(51) Int. Cl. B23P 13/04

(52) U.S. Cl. 29/557

(57) ABSTRACT

A plurality of sets of clampable jaws are positioned on cooperating pairs of sub-towers, one of each pair moves along the x-axis and one along the y-axis. In using the apparatus, fenestration product frame members which have been precisely cut to a desired cut length are placed in the clampable jaws. The frame members are positioned so that their ends are in non-touching proximity to radiant heater and a limited length of the ends of the frame members melted and then quickly brought into contact to effect welding of the joints. The precision placement of the precisely cut frame members results in a low-flash window frame.

### CROSS-REFERENCE TO RELATED APPLICATIONS

The present application is a continuation-in-part of U.S. patent application Ser. No. 11/323,563, filed on Dec. 30, 2005, which is hereby incorporated by reference.

### BACKGROUND OF THE INVENTION

1. Field of the Invention

The present invention is directed to the field of building products. More particularly, the present invention is directed to a method and apparatus for manufacturing precision window and door frame (fenestration) products which have thermoplastic frames.

2. Background Art

Window frames were historically made of wood. Wood is readily available, conventionally stable, machinable and has good thermal insulation qualities. Wood however is susceptible to rot, requires periodic maintenance and is becoming increasingly more expensive. In recent years vinyl windows have grown in popularity. Vinyl window frames require minimal maintenance, have good thermal qualities and are weldable to form a secure leak proof corner joint. As a result of the corner welding process there can be significant size variation in vinyl window frames. Wood windows can be constructed by cutting the wood frame members to size ±0.015 inches and joined with a secure rabbit joint with waterproof glue. Vinyl however is more difficult to accurately cut due to a low rigidity in thermal expansion and melt back during contact type hot plate welding of the corners. This commonly results in frame size variations of about 0.250 inches. This size variation requires larger gaps between window frame components and correspondingly thicker wider seals.

Vinyl windows have been mass produced using a welding process for some time. A typical prior art welding process involves (i) cutting the members to be welded to size within a tolerance of ±0.125 inches of a desired cut length; (ii) positioning the members in contact with a heater having a temperature of 450 to 525F.° for a period of time of 18 to 20 seconds to melt 0.187 to 0.325 inches of each of the ends of the members; and (iii) contacting ends of adjacent members together for a time period of 18 to 20 seconds to form a welded joint between the ends of the adjacent members. Note, that the desired cut length of the members is generally longer than the desired finish length of the members in the assembled frame. The reason is that end portions of each of the members are melted when heated, and the melted portions form the weld joint and the flash when the members are joined together. Thus, cut lengths have a longer length than the desired finish lengths so that after the melted portions form the weld flash, the desired finish length is achieved. A schematic graphical representation of such a prior art process can be seen in FIG. 9. While this process has proved to be acceptable, the mass production of quality vinyl windows has been problematic throughout the industry. Welding of the window has typically led to the formation of significant amount of flashing at the joints.

A typical flash at a joint can be 0.125 inches high and 0.250 inches wide. This amount of flash is usually unacceptable to most discerning consumers and thus requires a labor intensive process for inspection and removal that can be both costly and time consuming. Further, the flash removal process can result in scarring of the surface increasing scrap rate. At least one patent has purportedly dealt with the problem by using radiant heating to avoid contamination of the ends of the frame members and to reduce undesirable melting of excess plastic on the ends which necessarily produces a flashing bead that requires milling or shearing off. However, the patent fails to address an additional issue which contributes to the production of the bead: the need for tight tolerances on both the length of the frame member and the precision placement of the members during welding to avoid excess interference caused by compression of the frame members together which not only produces the flashing bead but also produces variance in the size of the end product.

Typically, vinyl window frames are welded using a heating station having a contact type heating plate and a pneumatic fixture which moves the frame members relative to fixed stops. These systems are difficult to adjust to change window size and have frame size variation due to variation in heating of the frame ends and in the pneumatic pressure based nature of the welding process.

### SUMMARY OF THE INVENTION

One facet of the present invention is a method of manufacturing a thermoplastic fenestration product having a desired design height and width, the steps comprising a) cutting two horizontal frame members within tolerances of 0.015 or 0.030 inches of a desired cut length; b) cutting two vertical frame members within tolerances of 0.015 or 0.030 inches of the desired cut length; c) positioning each of the two horizontal frame members and two vertical frame members in a respective pair of clampable jaws, each pair of clampable jaws being movable relative to an adjacent pair of clampable jaws by means of servo actuators; d) moving a set of sizing plates into a first operational position; e) activating the servo actuators to move the sub-towers with the clampable jaws with the horizontal and vertical frame members therein to positions with each end of the horizontal and vertical frame members in engagement with a sizing plate; f) clamping each frame member in its respective pair of clampable jaws; g) moving a first set of the radiant heaters into a first operational position; h) activating the servo actuators to move each end of each of said horizontal and vertical frame members into a heating position for a desired period of time sufficient to melt a limited length of the end portion; i) activating the servo actuators to precisely bring the limited length of the end portions into contact to weld the two horizontal and two vertical frame members into a frame; whereby the frame is within 0.030 inch of the desired finish height and within 0.030 inch of the desired finish width. In a preferred embodiment, this process can be repeatable to within ±0.020 inches over a 10 foot finished size variation. In the preferred embodiment, the sizing plates and the radiant heaters form portions of the same member such that the step of moving the radiant heaters into first operational positions requires displacing the sizing plates from their first operational positions.

The method further comprises the steps of a) positioning each of a second pair of two precision cut horizontal frame members in a second pair of clampable jaws on the same sub-towers as said first pair of horizontal frame members, b) positioning each of a second pair of two precision cut vertical frame members in a second pair of clampable jaws on the same sub-towers as said first pair of vertical frame members, whereby a second precisely dimensioned frame is manufactured simultaneously with the first frame.

Another aspect of the present invention involves an apparatus for manufacturing a fenestration product within ±0.075 inches and preferably within ±0.030 inch of a desired finish length. The apparatus comprising: four towers having portions mounted for relative lateral and longitudinal movement with respect to each other, each tower having i) a first sub-tower mounted for relative lateral movement, at least one first pair of clampable jaws mounted on the first sub-tower for clamping a first vertically extending fenestration frame member cut within tolerances of ±0.025 inch of a desired cut length; ii) a second sub-tower mounted for relative longitudinal movement, each second sub-tower being mounted adjacent a first sub-tower, at least one second pair of clampable jaws mounted on the second sub-tower for clamping a second horizontally extending fenestration frame member cut within tolerances of ±0.025 inch of a desired cut length; iii) a servo-actuator mounted on each sub-tower for precisely positioning the pairs of clampable jaws relative to adjacent sub-towers; b) a movable sizing plate mounted to move on a first axis which is aligned between each pair of first and second sub-towers; c) a movable radiant heating plate movable along the first axis between each pair of first and second sub-towers; whereby the servo-actuators move the clampable jaws on the adjacent sub-towers to position the ends of the first and second fenestration frame members in contact with opposite sides of the sizing plate, then to non-touching positions adjacent the radiant heating plate, then into precise engagement with one another to weld the frame members into a precisely sized frame.

In the preferred embodiment, the movable sizing plate and the movable radiant heating plate are portions of one member. The apparatus further comprises a second pair of clampable jaws on each sub-tower, the second set being positioned vertically above the first set of clampable jaws whereby a second precisely sized frame is manufactured simultaneously with the first precisely sized frame. A quick connect attachment means enable the jaw profiles to be quickly changed out for accommodating various fenestration member profiles.

Various other features, advantages, and characteristics of the present invention will become apparent after a reading of the following detailed description.

### BRIEF DESCRIPTION OF THE DRAWINGS

The preferred embodiments of the present invention are described in conjunction with the associated drawings in which like features are indicated with like reference numerals and in which:

FIG. 1 is a top plan view of a fenestration product made in accordance with at least one embodiment of the present invention;

FIG. 2 is a top perspective view of a first embodiment of the window manufacturing apparatus of the present invention;

FIG. 3 is a front perspective view of a single tower of the first embodiment;

FIG. 4 is a side perspective view of the single tower shown in FIG. 3;

FIG. 5A is a side view of a single sub-tower of the first embodiment;

FIG. 5B is a top plan view of the single sub-tower shown in FIG. 5A;

FIG. 5C is a front view of the single sub-tower;

FIG. 5D is a front perspective view detailing the quick-connect feature for the jaws;

FIG. 6A is a schematic view taken along line 6-6 of FIG. 1;

FIG. 6B is a view similar to FIG. 6A schematically representing an alternative embodiment of the present invention;

FIG. 7 is a schematic representation of a manufacturing step to make the product illustrated in FIG. 1;

FIG. 8 is a schematic representation of another manufacturing step to make the product illustrated in FIG. 1;

FIG. 9 is a schematic graphical representation of a prior art manufacturing process;

FIG. 10 is a schematic graphical representation of a manufacturing process in accordance with the present invention; and

FIGS. 11-18 illustrate a schematic representation of the manufacturing steps to make the product illustrated in FIG. 1.

### DETAILED DESCRIPTION OF THE PREFERRED EMBODIMENTS

As required, detailed embodiments of the present invention are disclosed herein. However, it is to be understood that the disclosed embodiments are merely exemplary of the invention that may be embodied in various and alternative forms. The Figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

Moreover, except where otherwise expressly indicated, all numerical quantities in this description and in the claims are to be understood as modified by the word “about” in describing the broader scope of this invention. Practice within the numerical limits stated is generally preferred. Also, unless expressly stated to the contrary, the description of a group or class of materials as suitable or preferred for a given purpose in connection with the invention implies that mixtures of any two or more members of the group or class may be equally suitable or preferred.

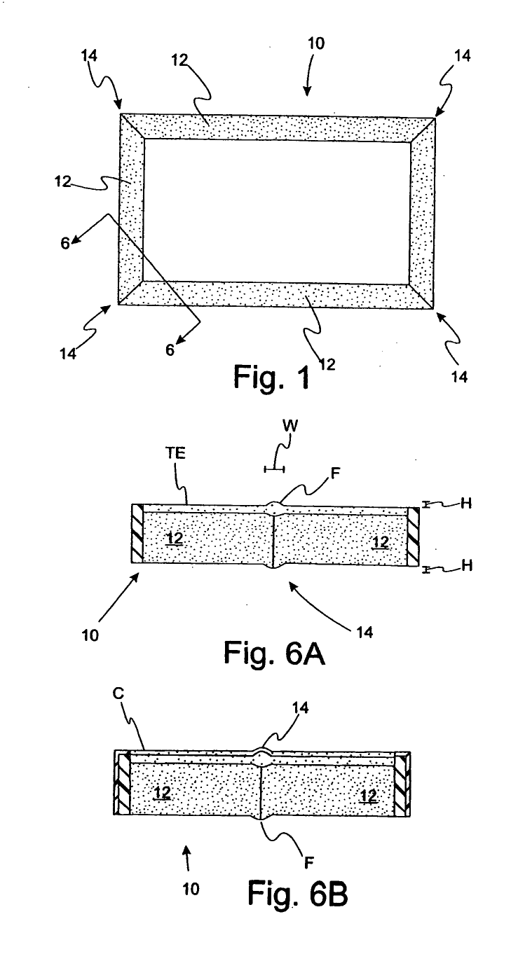

Referring now to the Figures, where like numerals are used to designate like structures throughout the drawings, a top plan view of a window frame in accordance with at least one embodiment of the present invention is generally shown at 10 in FIG. 1. The illustrated window frame 10 generally comprises four frame members 12 having opposing ends secured to a respective other frame member 12. The frame members 12 are secured or welded to each other in such a manner as to form four corner sections, each being generally indicated at 14. While the frame 10 is illustrated as having four corners, it should be understood that the principles of the present invention are applicable to frames having more or less than four corners.

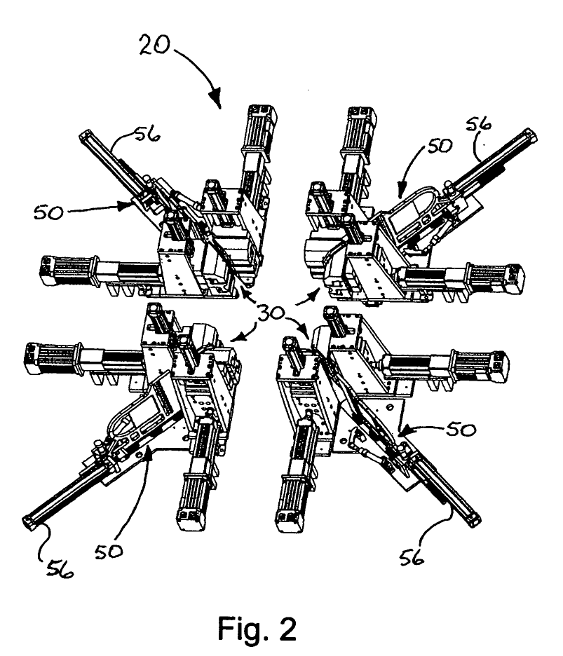

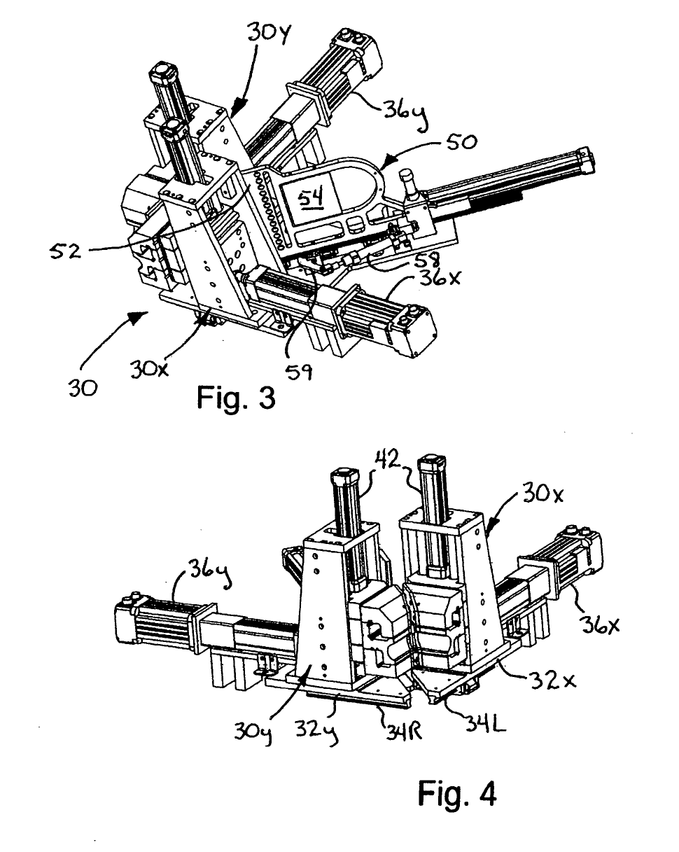

Referring now to FIG. 2, a first embodiment of a window manufacturing apparatus in accordance with another aspect of the present invention is depicted generally at 20. The apparatus 20 comprises four identical towers 30 which are movably mounted to define/form the four corners of a fenestration product, such as the window frame 10. The apparatus 20 is capable of making any type of thermoplastic material, such as but not limited to, PVC plastic fenestration products having corners. Examples of such fenestration products include, but are not limited to, window frames, such as the window frame 10, door frames, picture frames, and various window trims that fit around an exterior door or window. While it will be understood that the apparatus 20 is equally capable of manufacturing all types of fenestration products, throughout the balance of this description, the term window frame 10 will be used to identify the product being made. The support structure and the electrical and pneumatic lines have been omitted from the drawings for the sake of simplicity and clarity. These peripherals are conventional, for the most part, and their omission does not affect the description of the invention. Since the four towers 30 are identical, only one will be described in conjunction with FIGS. 3-5D, that description applying to each of the four.

As seen in FIGS. 3 and 4, each tower 30 comprises two sub-towers 30x and 30y which are respectively mounted for movement along the x-axis and movement along the y-axis on the underlying support structure. In the illustrated embodiment, slider plates 32x and 32y each have two dove-tail rails 34L and 34R which are received in complementarily shaped slots in the support. Sub-towers 30x and 30y are moved to and fro with slider plates 32x and 32y by precision indexing motors, such as servomotors 36x and 36y , respectively. While electric servomotors 36x and 36y are illustrated and described herein, it should be understood that other types of precision indexing motors could be used in lieu of electric servomotors. Examples of other precision indexing motors include, but are not limited to, stepper motors, microstep motors, and linear AC motors. Alternatively, a hydraulic servo system using a hydraulic cylinder or rotary motor could be used in place of the electric servomotor. The servo drive and associated control is preferably programable to allow frame size to be changed and to precisely move the heated frame ends to the weld joint location.

The operation of these illustrated servos 36x and 36y is precisely controlled to provide the desired positioning of the window frame components via a computer (not shown). It is this precision movement, in conjunction with controlling the length of the component frame members precisely and the use of non-contact radiant heating, which permits the production of relatively low-flash window frames.

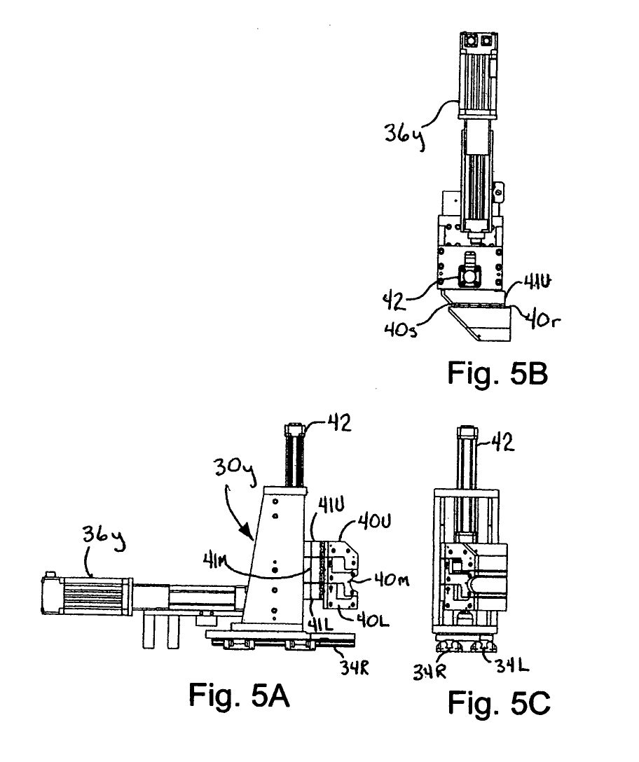

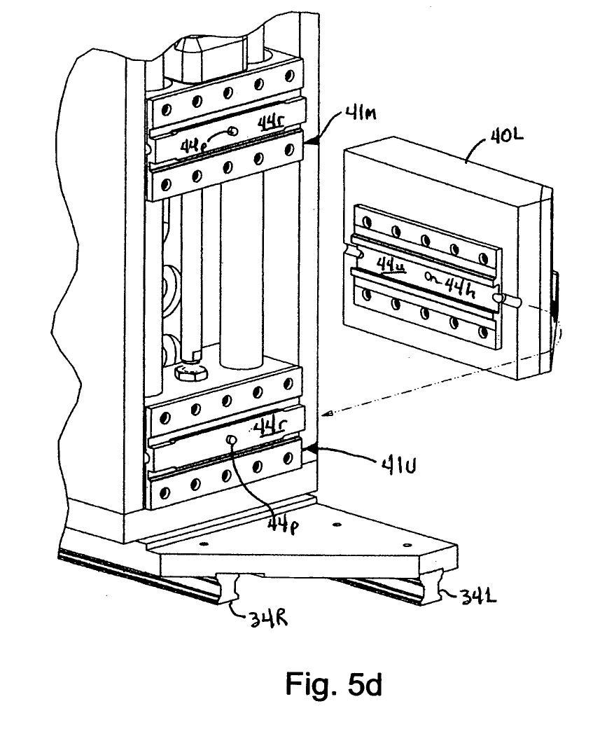

In the illustrated embodiment, each sub-tower 30x , 30y is equipped with three jaws 40U, 40M and 40L. Middle jaw 40M is stationary, while upper jaw 40U and lower jaw 40L, are simultaneously actuated by a pneumatic actuator 42. Each jaw is contoured to accommodate a particular profile of a frame member 12. In the illustrated embodiment, these jaws 40U, 40M and 40L are attached to upper, middle, and lower jaw plates 41U, 41M and 41L via dove tail slots 44s and dovetail rails 44r (FIG. 5D). However, it should be understood that the jaws 40U, 40M and 40L could be attached to the plates 41U, 41M and 41L in any suitable manner. A spring biased pin 44p is received in through-hole 44h. Through-hole 44h extends entirely through the thickness of jaw 40U so that pin 44p can be quickly depressed to allow jaw plates 41U, 41M and 41L to be changed out for differing frame member profiles. The use of three jaws enables two fenestration products to be simultaneously welded. The two parts may be related as in the case of a window frame and sash, with the frame being smaller than the sash. It should be understood however, that less (i.e., one) or more than two fenestration products could be simultaneously welded. For instance, fewer or different jaw plates could be used than those illustrated.

Between each set of sub-towers 30x and 30y, is a heater plate assembly 50. Heater plate assembly 50 includes a first forward section which comprises a sizing plate 52 and a rear portion which forms the heating plate 54. Heating plate 54 is a radiant heating plate which does not contact the frame members at any time, especially not during the period in which a limited length of the end portions of the frame members 12 are melted or softened or both. It will be understood that the in-line, single member heater plate assembly 50 works best when the angles of opposed cut ends of the profiles are essentially parallel when welding. Pneumatic cylinder 56 moves heater plate assembly 50 between a retracted position, a first active position in which sizing plate 52 is situated in a first operational position, and a second active position in which heating plate 54 is situated in a second operational position. A second pneumatic cylinder 58 positions a stop 59 to limit forward movement of first cylinder 56 so that the sizing plate is positioned in its first operational position.

In operation, with servomotors 36x, 36y having towers 30x, 30y in a rear, retracted position and pneumatic actuators 42 retracted (jaws 40U and 40L open), fenestration frame members 12 are loaded into the jaws 40M and 40L. In at least one embodiment, these frame members 12 have been precisely cut to the desired cut length ±0.025 and preferably ±0.015 inches using servo-driven feed system and saw blade. In another embodiment, the frame members 12 have been cut to the desired cut length ±0.010 inch, and in other embodiments to the desired cut length ±0.005 inch. In a preferred embodiment, a dust collection vacuum is provided at the cutting station to remove the cutting dust and debris in order to prevent dust from contaminating the weld joint. Pneumatic cylinder 58 is actuated to move stop 59 into its operative position so that activation of pneumatic cylinder 56 positions sizing plate in its first operative position. Then, with jaws 40U and 40L still open, servomotors 36x and 36y move sub-towers 30x, 30y to a forward position causing ends of vertical and horizontal frame members to come in contact with sizing plates 52. This properly positions frame members for future operations.

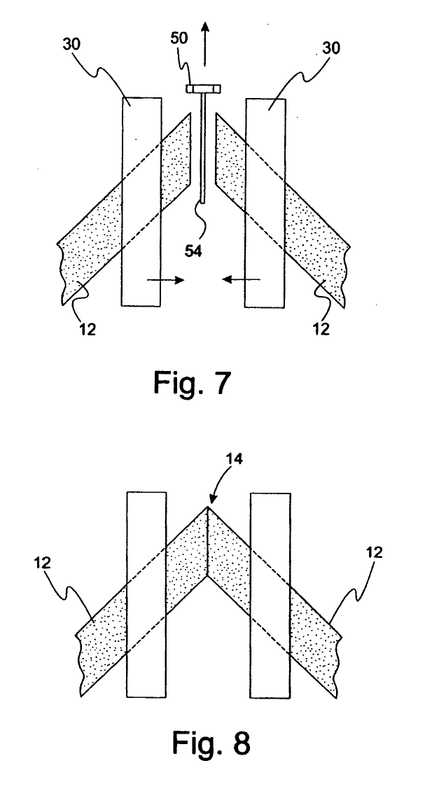

Pneumatic cylinder 58 retracts stop 59 allowing pneumatic cylinder 56 to move heater assembly 50 to its forward most position in which heater plate 54 is in its first operative position. This position is schematically illustrated in FIG. 7. In this position, the ends of the frame members 12 are spaced from each other. The ends of the frame members 12 are also spaced from a respective heater assembly 50 a sufficient distance to enable the ends of the frame member to melt due to the radiant heat of the heater assemblies 56. In at least one embodiment, the ends of the frame members are spaced 0.025 to 0.150 inches from a respective heater assembly 50, and in another embodiment 0.040 to 0.070 inches from a respective heater assembly. In at least one embodiment, the sides of heater plates 54 are recessed such that even in its most extended position, servomotors 36x, 36y are unable to bring the ends of frame members into contact with heater plates 54.

As schematically shown in FIG. 7, in at least one embodiment, the ends of the frame members 12 extend from the edge of a respective clap jaws of tower 30 between 0.025 to 0.100 inches, and in at least another embodiment 0.035 to 0.075 inches. In at least one embodiment, the heater plate 54 of the heater plate assembly 50 is at a temperature of 900° F. to 1300° F., and in at least another embodiment of 1000° F. to 1050° F. In at least one embodiment, the ends of the members 12 are exposed to the heat from the heater assembly 50 for a period of 4 to 15 seconds, and in at least another embodiment for 6 to 12 seconds. Thus, a controlled length of the ends of the frames are melted or softened or both, and there is no contamination which might otherwise occur were the melted plastic members to contact the heater plate 54.

After being exposed to the heat for a sufficient time period, servomotors 36x, 36y retract the sub-towers 30x, 30y slightly and the pneumatic cylinders 56 slide heater assembly 50 rearwardly on rail 53r to its rear most position. To prevent significant cooling of the ends of the members prior to joining, in at least one embodiment, less than 1.5 seconds after a respective heating assembly 50 has been removed from between adjacent members, the members are joined together. In at least another embodiment, the members are joined together within 0.025 to 0.75 seconds after a respective heater assembly 50 has been removed from between adjacent members, in at least yet another embodiment with 0.05 to 0.50 seconds, and in still yet another embodiment within 0.075 to 0.20 seconds.

Servomotors 36x and 36y then move sub-towers 30x, 30y forward a precise amount to bring molten ends of frame members into contact without either of the sub-towers 30x, 30y contacting or otherwise directly engaging the other sub-tower proximate the weld to confine or trim the flash bead, thus welding the frame members together (shown schematically in FIG. 8). In at least one embodiment, for 4 to 15 seconds, and in yet another embodiment for 6 to 9 seconds, the frame members are held together. Corners 14 are formed without creating a flashing bead, which would require subsequent machining. In at least one embodiment, the joint interference between adjacent ends of frame members 12 is between 0.010 to 0.150 inches, and in at least another embodiment between 0.025 to 0.050 inches. In at least one embodiment, the lengths of the members of the resulting fenestration product are within ±0.075 inches and preferably ±0.030 inches of the desired finish length. In at least another embodiment the length of the members of the resulting fenestration product are within ±0.020 inch of the desired length. This provides several advantages to the resulting window frame 10 manufactured using this apparatus/technique. The window frame 10 has reduced air infiltration and higher wind-load design pressures. This is achievable since the frame 10 of the present invention allows for relatively tighter sash to frame tolerance and relatively precise seal and durometer fit. In addition, as a result of the tighter tolerances, there will routinely be less frictional operating forces when sliding in the track of the window/door opening. It should be noted without the precision positioning afforded by the present invention, the frame members could not be cutting or positioned precisely enough to avoid the creation of an aesthetically unacceptable flashing bead. This adds to production costs and scrap rate, and reduces the quality and adversely affects the aesthetic appearance of the product.

The frame 10 made in accordance with the present invention can result in a minimal amount of flash that is visually acceptable by discerning customers. As shown in FIG. 6A, the flash F extends (i.e., has a height H of) 0.015 to 0.075 inches, and in yet another embodiment, 0.030 to 0.050 inches, from the top edge TE of the frame 10. The amount of flash also depends in part on the size of the gap between sub-towers 30x and 30y which remain in non-touching proximity as the weld is created.

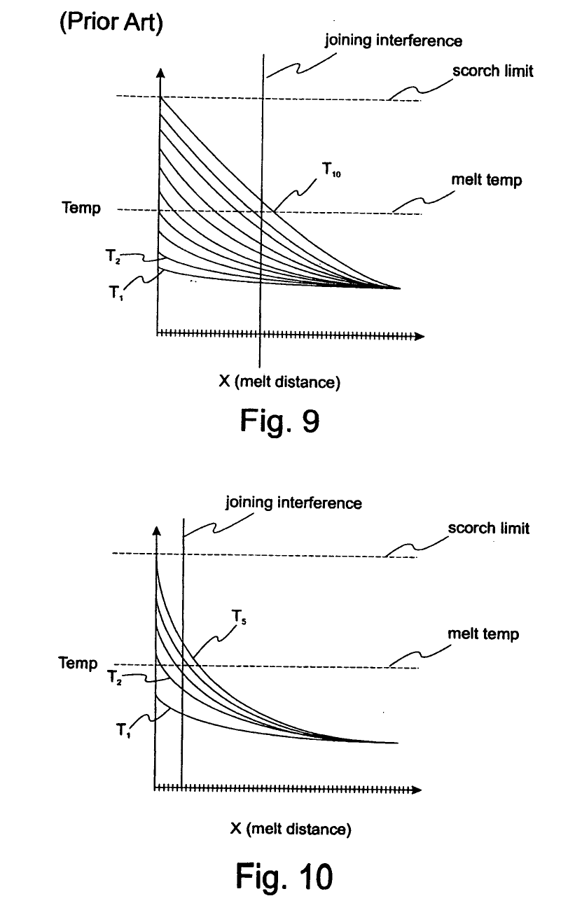

A schematic illustrative representation of the manufacturing process in accordance with the present invention can be seen in FIG. 10. As can be seen when comparing to the prior art process represented in FIG. 9, the members are heated very quickly (about 20 times faster than in the prior art), which enables a controlled melting of the ends of the members. This enables less joining interference resulting in a small, visually acceptable flash, as opposed to a wide and high flash (which needs to be trimmed) in the prior art. Using the method of the present invention results in frames having tight production tolerances (±0.030 inches) and strong welds.

Comparing FIGS. 9 and 10, the differences between the prior art and the preferred embodiment of the invention can be better appreciated. The X axis represents the distance from the free cut end of the frame member. The extreme left side of the axis is the cut surface. The linear distance from the cut surface is represented along the X axis. The Y axis represents the temperature of the thermoplastic frame material. The frame originally starts out at ambient temperature; once the heater is turned on for a period of time T ₁, the temperature profile changes with the end of the frame member beginning to heat up as illustrated. Note that the present invention heats the frame member more rapidly by comparing the T₁ curve in FIG. 10 versus the T₁, curve in the prior art FIG. 9 illustration. In the prior art, it takes approximately 10 units of time before the frame reaches the desired joining temperature, while the embodiment of the invention illustrated in FIG. 10 is heated in half of the time. When the prior art frame has reached the joining temperature, the heat zone has penetrated a much greater distance X into the end of the frame. The prior art frames have a relatively large joining interference, which is the distance the two frame ends move into one another. The present invention has a reduced joining interference as a result of the improved tolerances on frame member length and physical positioning. Note that in both instances, the frame member at the joining interference point has exceeded the melt or melt temperature of the thermoplastic material, while the free end of the material is lower than the scorch limit. The resulting frame made using the present invention exhibits excellent dimensional uniformity with minimal flash at each of the corner joints as a result of the limited interference.

While the preferred embodiment of this invention utilizes a radiant non-contact heater, it is possible, but not preferred to utilize a contact type heater plate. A contact type heater will achieve many of the uniformity and size benefits of the present invention, however, a larger flash bead would likely be formed.

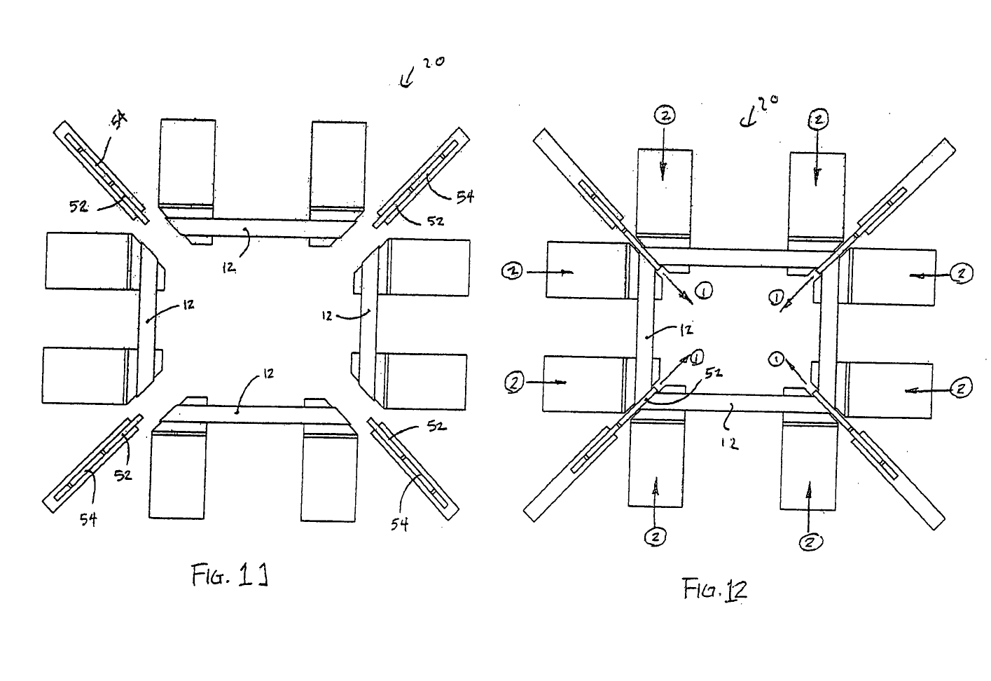

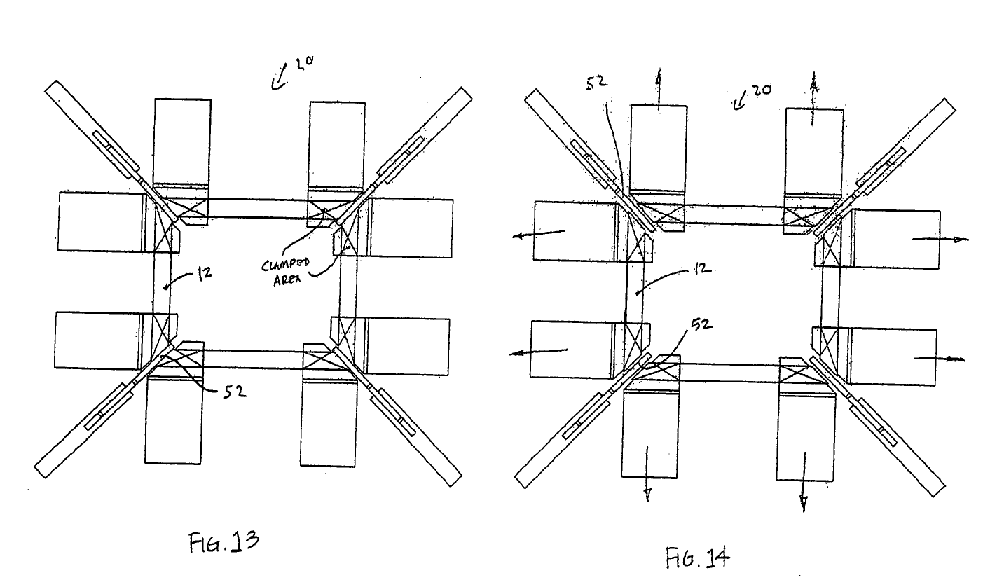

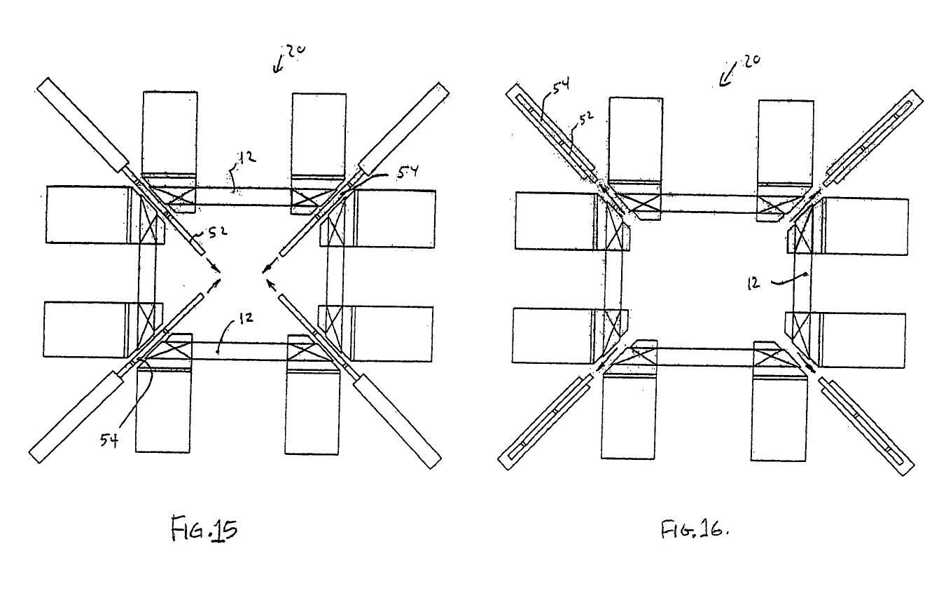

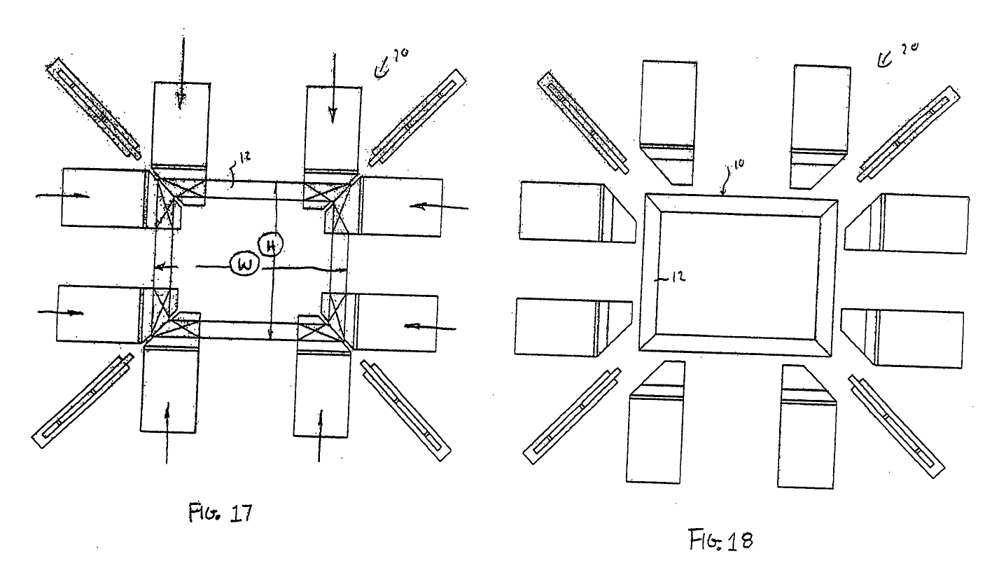

FIGS. 11-18 illustrate a schematic representation of the manufacturing steps to make the window frame 10 illustrated in FIG. 1. In FIG. 11, the frame members 12 are loaded into the apparatus 20. In FIG. 12, the sizing plates 52 are moved to the operational position and then the frame members 12 are bought into contact with sizing plates 52. In FIG. 13, the frame members 12 are clamped to the apparatus, and in FIG. 14, the frame members are moved away from each other so that sizing plate 52 can be moved. In FIG. 15, the heat plates 54 are moved into position between the ends of the frame member 12. In FIG. 16, the heat plates 54 are retracted, and in FIG. 17, the frame members 12 are joined together to weld the frame members to each other. In FIG. 18, the frame 10 is unclamped from the apparatus 20 for removal.

The present invention can be applicable to various types of thermoplastic materials. For instance, the frame members 12 could be made of PVC, PVC with a laminated PVC covering, such as a wood grain lamination, or painted PVC. In accordance with the present invention, the ability to produce a small flash amount enables not only visibly acceptable thermoplastic frames to be manufactured, but visually acceptable laminated and/or painted thermoplastic frames to be manufactured. The relatively small amount of flash F does not create a noticeable gap of uncovered thermoplastic between covered thermoplastic portions of the frame 10, that would normally be created by prior art manufacturing techniques. For instance, in the prior art, with flashes having a height of 0.1875 inch and a width of 0.1875 inch, when the flash is trimmed, a gap of 0.125 inches in width is typically created at the corner. In the case of laminated or painted PVC frames, the underlying PVC is typically white. For frames that are coated with paint or laminate (such as a woodgrain veneer), this gap must be touched up. While touching up paint is relatively easy (although time consuming and labor intensive), touching up veneers are very difficult, if not impossible, to do. An example of such a frame 10 comprising frame members 12 being made of PVC covered by a covering C of paint or lamination can be seen in FIG. 6B.

The frame 10 made in accordance with the present invention not only has acceptable visual characteristics but also beneficial physical properties. Because the amount of melt of the ends of the frame members 12 can be sufficiently controlled, the corners 14 have superior physical properties relative to the corners in the prior art. For instance, the strength of the weld between ends of the respective frame members 12 is stronger than prior art weld strengths.

The relatively high weld strength is believed to be at least in part due to the relatively low amount of polyenes created by the manufacturing method of the present invention. During manufacture, polyenes can be created from exposing PVC and other thermoplastics to heat, i.e., the degradation of the PVC. In accordance with the present invention, less polyenes are created since the length of the members 12 exposed to heat sufficient to cause significant degradation of the thermoplastic material is reduced by 66% over existing methods. Comparative structural teaching of corners in accordance with AAMA Standard Specifications for Windows, 5.3.6.2. “Thermoplastic corner weld test” has shown that the rupture strength of the welds produced with this method have on average higher rupture strengths than the prior art methods.

Various, changes, alternatives, and modifications will become apparent to one of ordinary skill in the art following a reading of the foregoing specification. It is intended that any such changes, alternatives, and modifications as fall within the scope of the appended claims be considered part of the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of manufacturing a thermoplastic fenestration product having a desired finish length and width, the steps comprising:
a) cutting each of two horizontal frame members to a desired cut length;
b) cutting two vertical frame members to a desired cut length;
c) positioning each of the two horizontal frame members and two vertical frame members in a respective pair of clampable jaws, each pair of clampable jaws being mounted on a sub-tower which is movable relative to an adjacent pair of clampable jaws and associated sub-tower by means of servo actuators;
d) moving a set of sizing plates into a first operational position;
e) activating said servo actuators to move said sub-towers with said clampable jaws with said horizontal and vertical frame members therein to positions with each end of said horizontal and vertical frame members in engagement with a sizing plate;
f) clamping each frame member in its respective pair of clampable jaws;
g) moving a first set of said radiant heaters into a first operational position;
h) activating said servo actuators to move each sub-tower and the associated ends of each of said horizontal and vertical frame members into non-touching proximity to one of the radiant heaters for a desired period of time sufficient to melt a limited length of said end portion; and
i) activating said servo actuators to precisely bring said limited length of said end portions into contact to weld said two horizontal and two vertical frame members into a frame of the desired size.

2. The method of claim 1 wherein the sizing plates and the radiant heaters form portions of the same member such that said step of moving the radiant heaters into first operational positions requires displacing the sizing plates from their first operational positions.

3. The method of claim 1 further comprising the steps of a) positioning each of a second pair of two precision cut horizontal frame members in a second pair of clampable jaws on the same sub-towers as said first pair of horizontal frame members, b) positioning each of a second pair of two precision cut vertical frame members in a second pair of clampable jaws on the same sub-towers as said first pair of vertical frame members, whereby a second precisely dimensioned frame is manufactured simultaneously with the first frame.

4. Apparatus for manufacturing a fenestration product within ±0.030 inch of a desired finish length, said apparatus comprising:
a) four towers having portions mounted for relative lateral and longitudinal movement with respect to each other, each tower having:
i) a first sub-tower mounted for relative lateral movement, at least one first pair of clampable jaws mounted on said first sub-tower for clamping a first vertically extending fenestration frame member cut to a desired first cut length;
ii) a second sub-tower mounted for relative longitudinal movement, said second sub-tower being mounted adjacent a first said sub-tower, at least one second pair of clampable jaws mounted on said second sub-tower for clamping a second horizontally extending fenestration frame member cut within tolerances of ±0.025 inch of a desired second cut length;
iii) a servo-actuator mounted on each sub-tower for precisely positioning said pairs of clampable jaws relative to adjacent sub-towers;
b) a movable sizing plate mounted to move on a first axis aligned between each pair of first and second sub-towers;
c) a movable heating plate movable along said first axis between each pair of first and second sub-towers;
whereby said servo-actuators move said clampable jaws on said adjacent sub-towers to position the ends of the first and second fenestration frame members to opposite sides of said sizing plate, and subsequent to heating into precise engagement with one another to weld the frame members into a precisely sized frame.

5. The apparatus of claim 4 wherein said heating plate comprises a radiant heating plate which heats the frame ends without direct contact.

6. The apparatus of claim 4 wherein the heating plates comprise a contact type heating plate which directly engages the ends of the frame.

7. The apparatus of claim 4 further comprising a second pair of clampable jaws on each said sub-tower, said second set being positioned vertically above said first set of clampable jaws whereby a second precisely sized frame is manufactured simultaneously with said first precisely sized frame.

8. The apparatus of claim 7 wherein jaws having specific profiles are connected to jaw plates of said first pair and said second pair of clampable jaws by a quick-connect attachment means.

9. The apparatus of claim 8 wherein said quick-connect attachment means comprises a dovetail rail on one of said members including said jaw plate and said jaw and a dovetail slot on the other of said included members.

10. The apparatus of claim 8 further comprising a depressible spring-biased pin on said dovetail rail and a hole in said dovetail slot.

11. The apparatus of claim 10 wherein said hole extends completely through said member to which said dovetail slot is attached whereby an elongated article can be inserted into said hole, said depressible spring-biased pin collapsed and said dovetail slot removed from said dovetail rail.

12. A method of manufacturing a thermoplastic fenestration product having a desired finish height and width, the steps comprising:
a) providing two horizontal frame members within tolerances of ±0.025 inch of a desired cut length;
b) providing two vertical frame members within tolerances of ±0.025 inch of a desired cut length;
c) providing four radiant heaters having a temperature of 900 to 1300° F.;
d) moving each end of each of said horizontal and vertical frame members into non-touching proximity to one of the radiant heaters for a period of time of 4 to 15 seconds; and
e) bringing each of said end portion into contact for a period of time of 4 to 15 seconds to cause a joint interference of 0.01 to 0.015 inches to weld said two horizontal and two vertical frame members into a frame;
whereby the resulting frame is within ±0.030 inch of said desired finish height and within ±0.030 inch of said desired finish width dimension.

13. The method of claim 12 wherein the frame members are within tolerances of ±0.015 inch of a desired finish dimension length.

14. The method of claim 12 wherein the frame members are made of PVC.

15. The method of claim 12 wherein each of the ends of the frame members are spaced 0.025 to 0.100 inches from a respective one of the heaters.

16. The method of claim 12 wherein the joint interference is 0.025 to 0.050 inches.

17. The method of claim 12 wherein the joints form a raised flash portion having a height of 0.015 to 0.075 inches and a width of 0.015 to 0.075 inches.

18. The method of claim 12, wherein step (d) further comprises moving each end of each of said horizontal and vertical frame member by servo actuators.

19. A method of manufacturing a thermoplastic fenestration product having a desired finish height and width, the steps comprising:
a) providing two horizontal frame members cut within tolerances of ±0.025 inch of a desired cut length;
b) providing two vertical frame members cut within tolerances of ±0.025 inch of a desired cut length;
c) positioning each of the two horizontal frame members and two vertical frame members in a spaced apart relation;
d) exposing each end of each of said horizontal and vertical frame members into non-touching proximity to a respective radiant heater having a temperature of 900 to 1300° F. for a period of time sufficient to melt a length of said end portion; and
e) bringing said end portions into contact to weld said two horizontal and two vertical frame members into a frame having four corners;
whereby the resulting frame is within ±0.030 inch of said desired finish height and within ±0.030 inch of said desired finish width dimension.

20. The method of claim 19 wherein the joint interference is 0.025 to 0.050 inches.

21. The method of claim 19 wherein the frame corners are provided with a raised flash portion having a height of 0.015 to 0.075 inches and a width of 0.015 to 0.075 inches.

22. The apparatus of claim 4 wherein the ends of the first and second fenestration products are positioned into precise engagement with one another without said clamping jaws on said adjacent sub-towers contacting each other proximate the flash region.

23. The method of claim 1 wherein the frame member end portions are brought into contact while their associated clamping jaws remain in spaced apart non-touching proximity to each other to define a flush region therebetween.
